(19) United States
(12) Patent Application Publication
(10) Pub. No.: US 2026/0371233 A1
(43) Pub. Date: Nov. 19, 2026

(54) NSSAI MANAGEMENT METHOD

(71) Applicant: LG ELECTRONICS INC., Seoul (KR)

(72) Inventors: Hyunjung CHOE, Seoul (KR); Myungjune YOUN, Seoul (KR); Hyunsook KIM, Seoul (KR)

(21) Appl. No.: 19/126,570

(22) PCT Filed: Nov. 3, 2023
(86) PCT No.: PCT/KR2023/017520

§ 371 Date: May 1, 2025

Related U.S. Application Data
(60) Provisional application No. 63/423,039, filed on Nov. 6, 2022.

(51) Int. Cl. H04W 48/18; H04W 60/00

(52) U.S. Cl. CPC H04W 48/18; H04W 60/005

(57) ABSTRACT

Provided in one embodiment of the present disclosure is a method by which a NAS layer of a UE performs communication. The method comprises the steps of: receiving, from an upper layer of a UE, a service start request for a first service; transmitting, to an AMF, a registration request message including requested NSSAI, the requested NSSAI including first S-NSSAI related to the first service; receiving, from the AMF, a registration approval message including pending NSSAI, the pending NSSAI including the first S-NSSAI; storing the first S-NSSAI in a pending NSSAI list; receiving, from the upper layer of the UE, an indication for aborting the service start request for the first service; and deleting the first S-NSSAI from the pending NSSAI list on the basis of the indication.

### CROSS-REFERENCE TO RELATED APPLICATIONS

This application is the National Stage filing under 35 U.S.C. 371 of International Application No. PCT/KR2023/017520, filed on Nov. 3, 2023, which claims the benefit of U.S. Patent Application No. 63/423,039 filed on Nov. 6, 2022, which is hereby incorporated by reference herein in its entirety.

### TECHNICAL FIELD

The present specification relates to mobile communications.

### BACKGROUND ART

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

When the network performs authentication and authorization procedures for a network slice for a specific service, the network slice may be stored in the terminal as a Pending NSSAI. Once stored, its handling becomes problematic if the terminal no longer wants that particular service.

### SUMMARY

The terminal deletes NSSAIs for services it no longer wants from Pending NSSAI.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIG. 4 is a block diagram of a next generation cellular network.

FIG. 5 illustrates an example 5G system structure to which an implementation of the present specification may be applied.

FIGS. 6 and 7 show an example of a registration procedure to which implementations of the present disclosure is applied.

FIG. 8 shows the registration procedure related to the network slice.

FIG. 9 illustrates a procedure according to an embodiment of this specification.

FIG. 10 shows the procedure of the NAS layer of the UE according to disclosure of the present specification.

FIG. 11 shows the procedure of the UE according to disclosure of the present specification.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings The same reference numerals in the following drawings and/or descriptions may refer to the same and/or corresponding hardware blocks, software blocks, and/or functional blocks unless otherwise indicated.

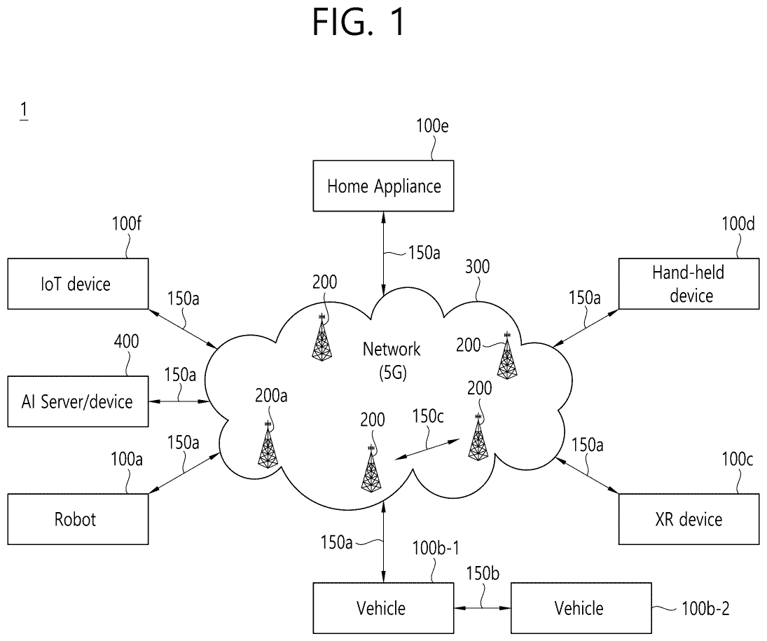

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

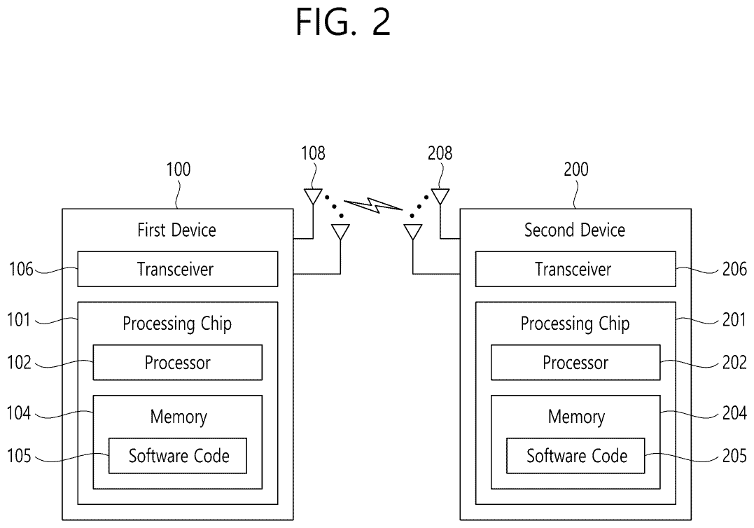

FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104, 204 may be associated with the one or more processors 102, 202 and may store various forms of data, signals, messages, information, programs, codes, instructions, and/or commands. The one or more memories 104, 204 may comprise random access memory (RAM), dynamic RAM (DRAM), read-only memory (ROM), erasable programmable ROM (EPROM), flash memory, volatile memory, non-volatile memory, hard drives, registers, cache memory, computer-readable storage media, and/or combinations thereof. The one or more memories 104, 204 may be located inside and/or outside of the one or more processors 102, 202. Further, the one or more memories 104, 204 may be coupled to the one or more processors 102, 202 via various technologies, such as wired or wireless connections.

The one or more transceivers 106, 206 may transmit user data, control information, wireless signals/channels, etc. referred to in the descriptions, features, procedures, suggestions, methods, and/or flowcharts of operation disclosed herein to one or more other devices. The one or more transceivers 106, 206 may receive user data, control information, wireless signals/channels, etc. referred to in the descriptions, features, procedures, suggestions, methods, and/or flowcharts of operation disclosed herein from one or more other devices. For example, the one or more transceivers 106, 206 may be associated with the one or more processors 102, 202 and may transmit and receive wireless signals. For example, the one or more processors 102, 202 may control the one or more transceivers 106, 206 to transmit user data, control information, wireless signals, etc. to one or more other devices. Further, the one or more processors 102, 202 may control the one or more transceivers 106, 206 to receive user data, control information, wireless signals, etc. from the one or more other devices.

The one or more transceivers 106, 206 may be associated with one or more antennas 108, 208. Additionally and/or alternatively, the one or more transceivers 106, 206 may include one or more antennas 108, 208. The one or more transceivers 106, 206 may be configured to transmit and receive, via the one or more antennas 108, 208, user data, control information, wireless signals/channels, etc. referred to in the descriptions, features, procedures, suggestions, methods, and/or flowcharts of operation disclosed herein. As used herein, the one or more antennas 108, 208 may be a plurality of physical antennas, or a plurality of logical antennas (e.g., antenna ports).

The one or more transceivers 106, 206 may convert the received user data, control information, radio signals/channels, etc. from RF band signals to baseband signals in order to process the received user data, control information, radio signals/channels, etc. using the one or more processors 102, 202. The one or more transceivers 106, 206 may convert the processed user data, control information, radio signals/channels, etc. from baseband signals to RF band signals using the one or more processors 102, 202. To do so, the one or more transceivers 106, 206 may include (analog) oscillators and/or filters. For example, the one or more transceivers 106, 206 may up-convert an OFDM baseband signal to an OFDM signal via an (analog) oscillator and/or filter under the control of the one or more processors 102, 202, and transmit the up-converted OFDM signal at the carrier frequency. The one or more transceivers 106, 206 may receive the OFDM signal at the carrier frequency and, under the control of the one or more processors 102, 202, down-convert the OFDM signal to an OFDM baseband signal via an (analog) oscillator and/or filter.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

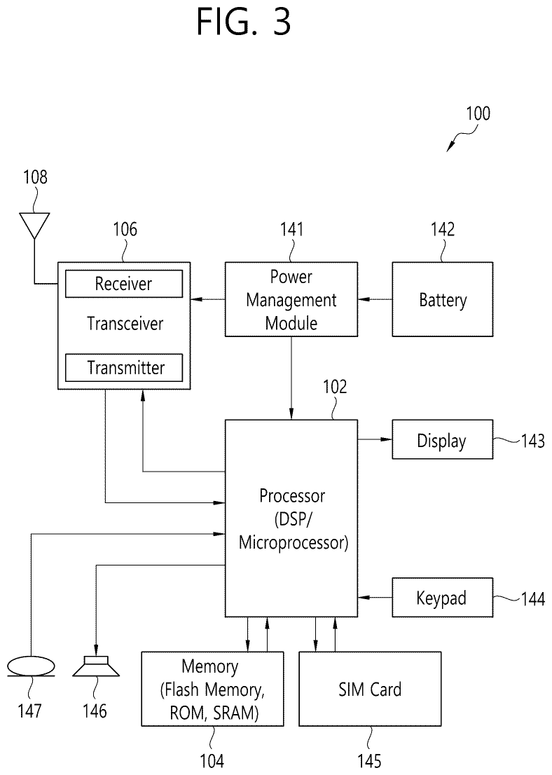

FIG. 3 shows an example of UE to which implementations of the present disclosure is applied.

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

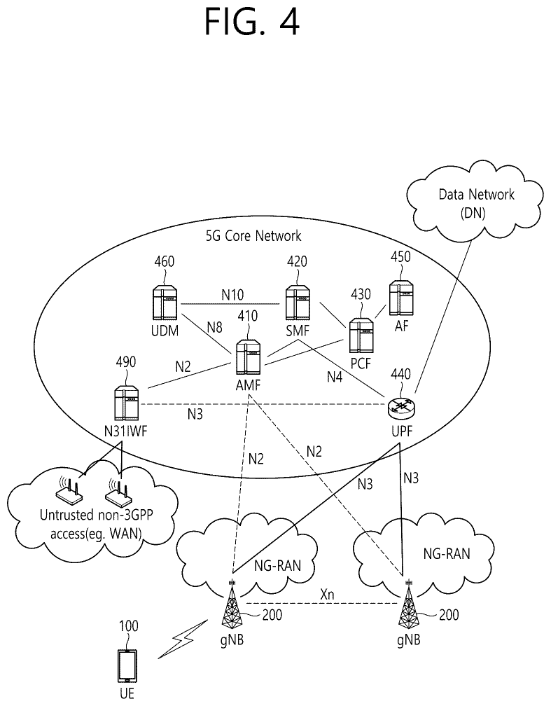

FIG. 4 is a block diagram of a next generation cellular network.

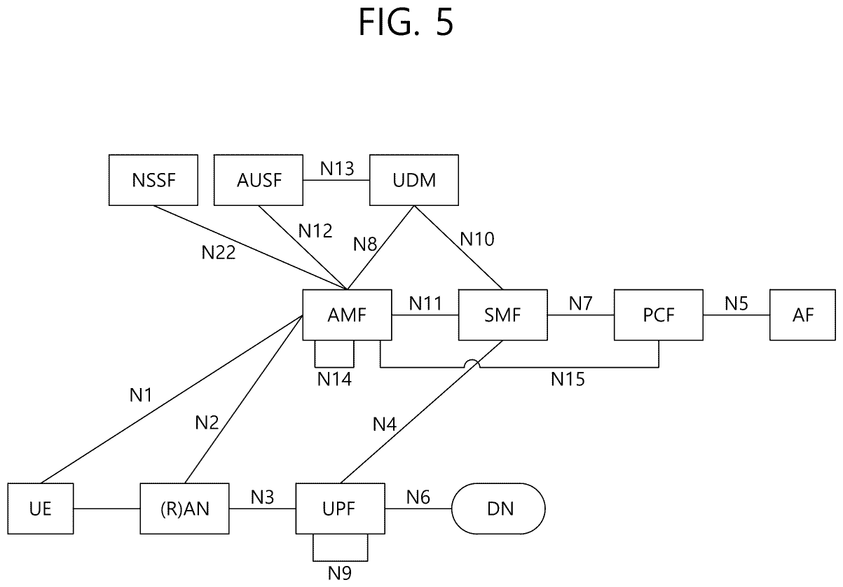

The 5G Core (5GC) may include a variety of components, some of which are shown in FIG. 5, such as the Access and Mobility Management Function (AMF) (410), the Session Management Function (SMF) (420), the Policy Control Function (PCF) (430), the User Plane Function (UPF) (440), the Application Function (AF) (450), the UDF (UDF) (450), and the UDF (UDF) (450): Policy Control Function (PCF) (430), User

Plane Function (UPF) (440), Application Function (AF) (450), Unified Data Management (UDM) (460), and Non-3rd Generation Partnership Project (3GPP) Inter Working Function (N3IWF) (490).

The UE 100 is connected to the data network via the UPF 440 through a next generation radio access network (NG-RAN) including the gNB 20.

The UE 100 may also be provided data services via untrusted non-3GPP access, such as a wireless local area network (WLAN). To connect said non-3GPP access to the core network, a N3IWF 490 may be deployed.

The illustrated N3IWF 490 performs the function of managing the interworking between the non-3GPP access and the 5G system. When the UE 100 is associated with a non-3GPP access (e.g., WiFi, also referred to as IEEE 801.11), the UE 100 may be associated with the 5G system via the N3IWF 490. The N3IWF 490 communicates with the AMF 410 for control signaling and with the UPF 440 via the N3 interface for data transfer.

The illustrated AMF 410 may manage access and mobility in a 5G system. The AMF 410 may perform functions to manage Non-Access Stratum (NAS) security. The AMF 410 may perform functions to handle mobility in an idle state.

The UPF 440 shown is a type of gateway through which user data is transmitted and received. The UPF node 440 may perform all or part of the user plane functions of the Serving Gateway (S-GW) and Packet Data Network Gateway (P-GW) of fourth generation mobile communications.

The UPF 440 acts as a demarcation point between the next generation radio access network (NG-RAN) and the core network, and is the element that maintains the data path between the gNB 20 and the SMF 420. Additionally, the UPF 440 acts as a mobility anchor point when the UE 100 moves across the area served by the gNB 20. The UPF 440 may perform functions to handle PDUs. For mobility within the NG-RAN (Next Generation-Radio Access Network as defined in 3GPP Release-15 and later), the UPF may route packets. The UPF 440 may also function as an anchor point for mobility with other 3GPP networks (RANs defined prior to 3GPP Release-15, e.g., UTRAN, E-UTRAN (Evolved-UMTS (Universal Mobile Telecommunications System) Terrestrial Radio Access Network), or GERAN (Global System for Mobile Communication (GSM)/EDGE (Enhanced Data rates for Global Evolution) Radio Access Network). The UPF 440 may correspond to a termination point of the data interface to the data network.

The PCF 430 shown is a node that controls the operator's policies.

The AF 450 shown is a server for providing multiple services to the UE 100.

The UDM 460 shown is a type of server that manages subscriber information, such as a home subscriber server (HSS) in fourth generation mobile communications. The UDM 460 stores and manages subscriber information in a unified data repository (UDR).

The SMF 420 shown may perform the function of assigning an Internet Protocol (IP) address of a UE. The SMF 420 may also control protocol data unit (PDU) sessions.

As a point of reference, the drawing symbols for AMF 410, SMF 420, PCF 430, UPF 440, AF 450, UDM 460, N3IWF 490, gNB 20, or UE 100 may be omitted herein.

Fifth generation mobile communications supports multiple numerologies or subcarrier spacings (SCS) to support various 5G services. For example, an SCS of 15 kHz supports wide area coverage in traditional cellular bands; an SCS of 30 kHz/60 kHz supports dense-urban, lower latency, and wider carrier bandwidth; and an SCS of 60 kHz or higher supports bandwidths greater than 24.25 GHz to overcome phase noise.

FIG. 5 illustrates an example 5G system structure to which an implementation of the present specification may be applied.

The 5G system (5GS; 5G system) structure consists of the following network functions (NFs).
AUSF (Authentication Server Function)
AMF (Access and Mobility Management Function)
DN (Data Network), e.g., operator services, internet access or third-party services
USDF (Unstructured Data Storage Function)
NEF (Network Exposure Function)
I-NEF (Intermediate NEF)
NRF (Network Repository Function)
NSSF (Network Slice Selection Function)
PCF (Policy Control Function)
SMF (Session Management Function)
UDM (Unified Data Management)
UDR (Unified Data Repository)
UPF (User Plane Function)
UCMF (UE radio Capability Management Function)
AF (Application Function)
UE (User Equipment)
(R) AN ((Radio) Access Network)
5G-EIR (5G-Equipment Identity Register)
NWDAF (Network Data Analytics Function)
CHF (Charging Function)

In addition, the following network functions may be considered.
N3IWF (Non-3GPP InterWorking Function)
TNGF (Trusted Non-3GPP Gateway Function)
W-AGF (Wireline Access Gateway Function)

FIG. 5 shows the 5G system structure of a non-roaming case using a reference point representation that shows how various network functions interact with each other.

In FIG. 5, UDSF, NEF and NRF are not described for clarity of the point-to-point diagram. However, all network functions shown may interact with UDSF, UDR, NEF and NRF as needed.

For clarity, the connection between the UDR and other NFs (e.g., PCFs) is not shown in FIG. 5. For clarity, the connection between NWDAF and other NFs (e.g. PCFs) is not shown in FIG. 5.

The 5G system architecture includes the following reference points.
N1: the reference point between the UE and the AMF.
N2: reference point between (R) AN and AMF.
N3: Reference point between (R) AN and UPF.
N4: reference point between SMF and UPF.
N6: Reference point between UPF and data network.
N9: reference point between two UPFs.

The following reference points show the interactions that exist between NF services in NF.
N5: Reference point between PCF and AF.
N7: reference point between SMF and PCF.
N8: reference point between UDM and AMF.
N10: reference point between UDM and SMF.
N11: reference point between AMF and SMF.
N12: reference point between AMF and AUSF.
N13: reference point between UDM and AUSF.
N14: reference point between two AMFs.
N15: Reference point between PCF and AMF in case of non-roaming scenario, and reference point between PCF and AMF of visited network in case of roaming scenario.
N16: reference point between two SMFs (in case of roaming, between the SMF of the visited network and the SMF of the home network)
N22: reference point between AMF and NSSF.

In some cases, it may be necessary to connect two NFs to each other to service the UE.

### <Registration Procedure>

A registration procedure is described. Section 4.2.2.2 of 3GPP TS 23.502 V16.3.0 (2019 December) can be referred.

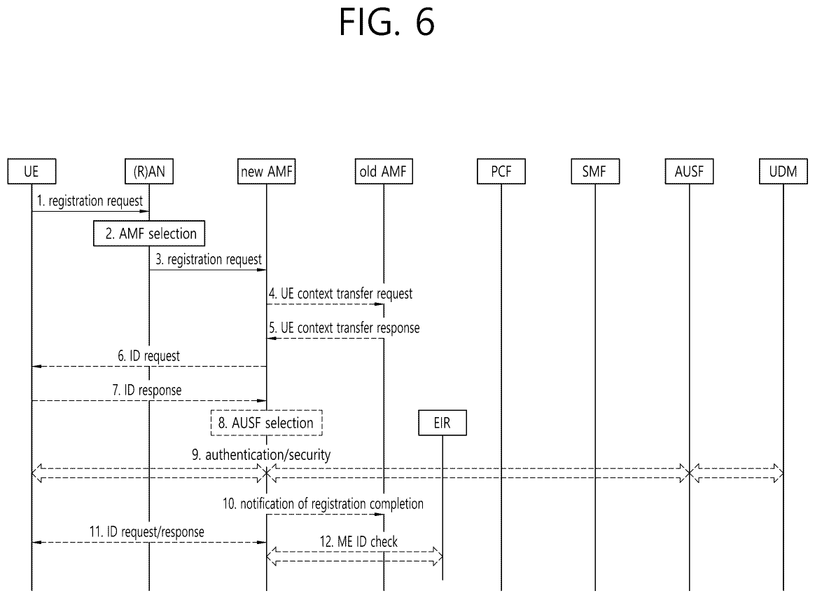

FIGS. 6 and 7 show an example of a registration procedure to which implementations of the present disclosure is applied.

A UE needs to register with the network to get authorized to receive services, to enable mobility tracking and to enable reachability. The UE initiates the registration procedure using one of the following registration types:
Initial registration to the 5GS; or
Mobility registration update; or
Periodic registration update; or
Emergency registration.

The general registration procedure in FIGS. 6 and 7 applies on all these registration procedures, but the periodic registration update need not include all parameters that are used in other registration cases.

The general registration procedure in FIGS. 6 and 7 is also used for the case of registration in 3GPP access when the UE is already registered in a non-3GPP access, and vice versa. Registration in 3GPP access when the UE is already registered in a non-3GPP access scenario may require an AMF change.

First, procedures of FIG. 6 are described.
(1) Step 1: The UE transmits a Registration Request message to the (R) AN. The Registration Request message corresponds to AN message.

The Registration Request message may include AN parameters. In the case of NG-RAN, the AN parameters include, e.g., 5G SAE temporary mobile subscriber identity (5G-S-TMSI) or globally unique AMF ID (GUAMI), the selected public land mobile network (PLMN) ID (or PLMN ID and network identifier (NID)) and Requested network slice selection assistance information (NSSAI). The AN parameters also include establishment cause. The establishment cause provides the reason for requesting the establishment of an RRC connection. Whether and how the UE includes the Requested NSSAI as part of the AN parameters is dependent on the value of the access stratum connection establishment NSSAI inclusion mode parameter.

The Registration Request message may include a registration type. The registration type indicates if the UE wants to perform an initial registration (i.e., the UE is in RM-DEREGISTERED state), a mobility registration update (i.e., the UE is in RM-REGISTERED state and initiates a registration procedure due to mobility or due to the UE needs to update its capabilities or protocol parameters, or to request a change of the set of network slices it is allowed to use), a periodic registration update (i.e., the UE is in RM-REGISTERED state and initiates a registration procedure due to the periodic registration update timer expiry) or an emergency registration (i.e., the UE is in limited service state).

When the UE is performing an initial registration, the UE shall indicate its UE identity in the Registration Request message as follows, listed in decreasing order of preference:
i) a 5G globally unique temporary identifier (5G-GUTI) mapped from an evolved packet system (EPS) GUTI, if the UE has a valid EPS GUTI.
ii) a native 5G-GUTI assigned by the PLMN to which the UE is attempting to register, if available;
iii) a native 5G-GUTI assigned by an equivalent PLMN to the PLMN to which the UE is attempting to register, if available;
iv) a native 5G-GUTI assigned by any other PLMN, if available.
v) Otherwise, the UE shall include its subscriber concealed identifier (SUCI) in the Registration Request message.

When the UE performing an initial registration has both a valid EPS GUTI and a native 5G-GUTI, the UE shall also indicate the native 5G-GUTI as additional GUTI. If more than one native 5G-GUTIs are available, the UE shall select the 5G-GUTI in decreasing order of preference among items (ii)-(iv) in the list above.

When the UE is performing an initial registration with a native 5G-GUTI, then the UE shall indicate the related GUAMI information in the AN parameters. When the UE is performing an initial registration with its SUCI, the UE shall not indicate any GUAMI information in the AN parameters.

For an emergency registration, the SUCI shall be included if the UE does not have a valid 5G-GUTI available; the permanent equipment identifier (PEI) shall be included when the UE has no subscriber permanent identifier (SUPI) and no valid 5G-GUTI. In other cases, the 5G-GUTI is included and it indicates the last serving AMF.

The Registration Request message may also include security parameters, PDU Session Status, etc. The security parameters are used for authentication and integrity protection. The PDU Session Status indicates the previously established PDU sessions in the UE. When the UE is connected to the two AMFs belonging to different PLMN via 3GPP access and non-3GPP access then the PDU Session status indicates the established PDU Session of the current PLMN in the UE.
(2) Step 2: The (R) AN selects an AMF.

If a 5G-S-TMSI or GUAMI is not included or the 5G-S-TMSI or GUAMI does not indicate a valid AMF, the (R) AN, based on (R) AT and requested NSSAI, if available, selects an AMF.

If UE is in CM-CONNECTED state, the (R) AN can forward the Registration Request message to the AMF based on the N2 connection of the UE.

If the (R) AN cannot select an appropriate AMF, it forwards the Registration Request message to an AMF which has been configured, in the (R) AN, to perform AMF selection.
(3) Step 3: The (R) AN transmits a Registration Request message to the new AMF. The Registration Request message corresponds to N2 message.

The Registration Request message may include whole information and/or a part of information included in the Registration Request message received from the UE which is described in step 1.

The Registration Request message may include N2 parameters. When NG-RAN is used, the N2 parameters include the selected PLMN ID (or PLMN ID and NID), location information and cell identity related to the cell in which the UE is camping, UE context request which indicates that a UE context including security information needs to be setup at the NG-RAN. When NG-RAN is used, the N2 parameters shall also include the establishment cause.

If the Registration type indicated by the UE is Periodic Registration Update, then steps 4 to 19 may be omitted.
(4) Step 4: If the UE's 5G-GUTI was included in the Registration Request message and the serving AMF has changed since last registration procedure, the new AMF may invoke the Namf_Communication_UEContextTransfer service operation on the old AMF including the complete registration request non-access stratum (NAS) message to request the UE's SUPI and UE context.
(5) Step 5: The Old AMF may respond to the new AMF for the Namf_Communication_UEContextTransfer invocation by including the UE's SUPI and UE context.
(6) Step 6: If the SUCI is not provided by the UE nor retrieved from the old AMF, the identity request procedure may be initiated by the new AMF sending the Identity Request message to the UE requesting the SUCI.
(7) Step 7: The UE may respond with an Identity Response message including the SUCI. The UE derives the SUCI by using the provisioned public key of the home PLMN (HPLMN).
(8) Step 8: The new AMF may decide to initiate UE authentication by invoking an AUSF. In that case, the new AMF selects an AUSF based on SUPI or SUCI.
(9) Step 9: Authentication/security may be established by the UE, new AMF, AUSF and/or UDM.
(10) Step 10: If the AMF has changed, the new AMF may notify the old AMF that the registration of the UE in the new AMF is completed by invoking the Namf_Communication_RegistrationCompleteNotify service operation. If the authentication/security procedure fails, then the registration shall be rejected, and the new AMF may invoke the Namf_Communication_RegistrationCompleteNotify service operation with a reject indication reason code towards the old AMF. The old AMF may continue as if the UE context transfer service operation was never received.
(11) Step 11: If the PEI was not provided by the UE nor retrieved from the old AMF, the Identity Request procedure may be initiated by the new AMF sending an Identity Request message to the UE to retrieve the PEI. The PEI shall be transferred encrypted unless the UE performs emergency registration and cannot be authenticated.
(12) Step 12: Optionally, the new AMF may initiate ME identity check by invoking the N5g-eir_EquipmentIdentityCheck_Get service operation.

Now, procedures of FIG. 7, which follow the procedures of FIG. 6, are described.
(13) Step 13: If step 14 below is to be performed, the new AMF, based on the SUPI, may select a UDM, then UDM may select a UDR instance.
(14) Step 14: The new AMF may register with the UDM.
(15) Step 15: The new AMF may select a PCF.
(16) Step 16: The new AMF may optionally perform an AM Policy Association Establishment/Modification.
(17) Step 17: The new AMF may transmit Update/Release SM Context message (e.g., Nsmf_PDUSession_UpdateSMContext and/or Nsmf_PDUSession_ReleaseSMContext) to the SMF.
(18) Step 18: If the new AMF and the old AMF are in the same PLMN, the new AMF may send a UE Context Modification Request to the N3IWF/TNGF/W-AGF.
(19) Step 19: The N3IWF/TNGF/W-AGF may send a UE Context Modification Response to the new AMF.
(20) Step 20: After the new AMF receives the response message from the N3IWF/TNGF/W-AGF in step 19, the new AMF may register with the UDM.
(21) Step 21: The new AMF transmits a Registration Accept message to the UE.

The new AMF sends a Registration Accept message to the UE indicating that the Registration Request has been accepted. 5G-GUTI is included if the new AMF allocates a new 5G-GUTI. If the UE is already in RM-REGISTERED state via another access in the same PLMN, the UE shall use the 5G-GUTI received in the Registration Accept message for both registrations. If no 5G-GUTI is included in the Registration Accept message, then the UE uses the 5G-GUTI assigned for the existing registration also for the new registration. If the new AMF allocates a new registration area, it shall send the registration area to the UE via Registration Accept message. If there is no registration area included in the Registration Accept message, the UE shall consider the old registration area as valid. Mobility Restrictions is included in case mobility restrictions applies for the UE and registration type is not emergency registration. The new AMF indicates the established PDU sessions to the UE in the PDU Session status. The UE removes locally any internal resources related to PDU sessions that are not marked as established in the received PDU Session status. When the UE is connected to the two AMFs belonging to different PLMN via 3GPP access and non-3GPP access then the UE removes locally any internal resources related to the PDU session of the current PLMN that are not marked as established in received PDU Session status. If the PDU Session status information was in the Registration Request message, the new AMF shall indicate the PDU Session status to the UE.

The Allowed NSSAI provided in the Registration Accept message is valid in the registration area and it applies for all the PLMNs which have their tracking areas included in the registration area. The Mapping Of Allowed NSSAI is the mapping of each S-NSSAI of the Allowed NSSAI to the HPLMN S-NSSAIs. The Mapping Of Configured NSSAI is the mapping of each S-NSSAI of the Configured NSSAI for the serving PLMN to the HPLMN S-NSSAIs.

Furthermore, optionally the new AMF performs a UE Policy Association Establishment.
(22) Step 22: The UE may send a Registration Complete message to the new AMF when it has successfully updated itself.

The UE may send a Registration Complete message to the new AMF to acknowledge if a new 5G-GUTI was assigned.
(23) Step 23: For registration over 3GPP Access, if the new AMF does not release the signaling connection, the new AMF may send the RRC Inactive Assistance Information to the NG-RAN. For registration over non-3GPP Access, if the UE is also in CM-CONNECTED state on 3GPP access, the new AMF may send the RRC Inactive Assistance Information to the NG-RAN.
(24) Step 24: The new AMF may perform information update towards the UDM.
(25) Step 25: The UE may execute Network Slice-Specific Authentication and Authorization procedure.

### <Network Slicing>

Describes network slicing. See section 4.6 of 3GPP TS 24.501 V16.4.1.

The 5GS supports network slicing. Within a PLMN or SNPN, a network slice is identified by an S-NSSAI, which is comprised of a slice/service type (SST) and a slice differentiator (SD). Inclusion of an SD in an S-NSSAI is optional. A set of one or more S-NSSAIs is called the NSSAI. The following NSSAIs may be defined:
a) configured NSSAI;
b) requested NSSAI;
c) allowed NSSAI;
d) subscribed S-NSSAIs; and
e) pending NSSAI.

The following NSSAIs may be defined:
a) rejected NSSAI for the current PLMN or SNPN;
b) rejected NSSAI for the current registration area;
c) rejected NSSAI for the failed or revoked NSSAA; and

In case of a PLMN, a serving PLMN may configure a UE with the configured NSSAI per PLMN. In addition, the HPLMN may configure a UE with a single default configured NSSAI and consider the default configured NSSAI as valid in a PLMN for which the UE has neither a configured NSSAI nor an allowed NSSAI. For SNPN, SNPN may set the UE to set the SNPN applicable to the SNPN.

The allowed NSSAI and the rejected NSSAI for the current registration area are managed per access type independently, i.e. 3GPP access or non-3GPP access, and is applicable for the registration area. If the registration area contains TAIs belonging to different PLMNs, which are equivalent PLMNs, the allowed NSSAI and the rejected NSSAI for the current registration area are applicable to these PLMNs in this registration area.

The allowed NSSAI that is associated with a registration area containing TAIs belonging to different PLMNs, which are equivalent PLMNs, can be used to form the requested NSSAI for any of the equivalent PLMNs when the UE is outside of the registration area where the allowed NSSAI was received.

When the network slice-specific authentication and authorization procedure is to be initiated for one or more S-NSSAIs in the requested NSSAI, these S-NSSAI(s) will be included in the pending NSSAI. When the network slice-specific authentication and authorization procedure is completed for an NSSAI that has been in the pending NSSAI, the S-NSSAI will be moved to the allowed NSSAI or rejected NSSAI depending on the outcome of the procedure, and are notified to the UE. The pending NSSAI is managed regardless of access type i.e. the pending NSSAI is applicable to both 3GPP access and non-3GPP access for the current PLMN even if sent over only one of the accesses.

The rejected NSSAI for the current PLMN or SNPN is applicable for the whole registered PLMN or SNPN. The AMF shall only send a rejected NSSAI for the current PLMN when the registration area consists of TAIs that only belong to the registered PLMN. If the UE receives a rejected NSSAI for the current PLMN, and the registration area also contains TAIs belonging to different PLMNs, the UE shall treat the received rejected NSSAI for the current PLMN as applicable to the whole registered PLMN.

The rejected NSSAI for the failed or revoked NSSAA includes one or more S-NSSAIs that have failed the network slice-specific authentication and authorization or for which the authorization have been revoked, and are applicable for the whole registered PLMN or SNPN.

Describes NSSAI storage. See section 4.6.2.2 of 3GPP TS 24.501 V16.4.1.

In general, Configured NSSAI is the subscribed NSSAI of the UE when the UE is connected to the HPLMN, and remains the same unless the subscriber information of the UE changes. However, an existing S-NSSAI may be created as Configured NSSAI due to a change in subscriber information, or a specific S-NSSAI may be removed. After that, the AMF may inform the UE of the updated S-NSSAI of the current connected network.

In addition, the UE may store and retain the Configured NSSAI for the network that the UE has visited in the non-volatile memory. Therefore, when the UE selects a new VPLMN, the Configured NSSAI information of the previously visited network may exist. Therefore, when performing PLMN selection, the UE may have the Configured NSSAI information of the PLMN that the UE has selected.

In addition, if there is an SLA (service level agreement) between the VPLMN and the HPLMN that the UE can access, the UE may know which HPLMN's S-NSSAI the VPLMN has.

If available, the Configured NSSAI is stored in the non-volatile memory of the UE. The Allowed NSSAI is stored in the non-volatile memory of the UE.

Each of the configured NSSAI stored in the UE is a set composed of at most 16 S-NSSAIs. Each of the allowed NSSAI stored in the UE is a set composed of at most 8 S-NSSAIs and is associated with a PLMN identity or SNPN identity, an access type. Each of the configured NSSAI except the default configured NSSAI, and the rejected NSSAI is associated with a PLMN identity or SNPN identity. The S-NSSAI(s) in the rejected NSSAI for the current registration area are further associated with one or more tracking areas where the rejected S-NSSAI(s) is not available. The S-NSSAI(s) in the rejected NSSAI for the current PLMN or SNPN shall be considered rejected for the current PLMN or SNPN regardless of the access type. The S-NSSAI(s) in the rejected NSSAI for the failed or revoked NSSAA shall be considered rejected for the current PLMN or SNPN regardless of the access type. There shall be no duplicated PLMN identities or SNPN identities associated with each of the list of configured NSSAI(s), pending NSSAI(s), rejected NSSAI(s) for the current PLMN or SNPN, rejected NSSAI(s) for the current registration area.

The UE stores NSSAIs as follows:
a) The configured NSSAI shall be stored until a new configured NSSAI is received for a given PLMN or SNPN. The network may provide to the UE the mapped S-NSSAI(s) for the new configured NSSAI which shall also be stored in the UE. When the UE is provisioned with a new configured NSSAI for a PLMN or SNPN, the UE shall:
1) replace any stored configured NSSAI for this PLMN or SNPN with the new configured NSSAI for this PLMN or SNPN;
2) delete any stored mapped S-NSSAI(s) for the configured NSSAI and, if available, store the mapped S-NSSAI(s) for the new configured NSSAI;
3) delete any stored allowed NSSAI for this PLMN or SNPN and, if available, the stored mapped S-NSSAI(s) for the allowed NSSAI, if the UE received the new configured NSSAI for this PLMN or SNPN and the Configuration update indication IE with the Registration requested bit set to “registration requested”, in the same CONFIGURATION UPDATE COMMAND message but without any new allowed NSSAI for this PLMN or SNPN included;
4) Delete rejected NSSAIs for the current PLMN or SNPN stored, rejected NSSAIs for the current registration area, and rejected NSSAIs for NSSAI and NSSAA failure or revoke.

If the UE receives an S-NSSAI associated with a PLMN ID from the network during the PDN connection establishment procedure in EPS, the UE may store the received S-NSSAI in the configured NSSAI for the PLMN identified by the PLMN ID associated with the S-NSSAI, if not already included in the configured NSSAI;

The UE may continue storing a received configured NSSAI for a PLMN and associated mapped S-NSSAI(s), if available, when the UE registers in another PLMN.
b) The allowed NSSAI is stored until a new allowed NSSAI is received for the given PLMN or SNPN. The network may also provide the UE with a mapped S-NSSAI for the new allowed NSSAI to be stored in the UE. When a new allowed NSSAI is received for a PLMN or SNPN, the UE does the following:
1) replace any stored allowed NSSAI for this PLMN or SNPN with the new allowed NSSAI for this PLMN or SNPN;
2) delete any stored mapped S-NSSAI(s) for the allowed NSSAI, if available, store the mapped S-NSSAI(s) for the new allowed NSSAI;
3) remove the S-NSSAI (if any) included in the newly allowed NSSAI for the current PLMN or SNPN from the stored rejected NSSAI;
4) remove one or more S-NSSAIs (if any) included in the newly allowed NSSAI for the current PLMN or SNPN from the stored pending NSSAIs.

When the UE receives a Configuration Update Command message with the Registration Request bit in the Configuration Update Instruction IE set to “Registration Request” and no other parameters, the UE deletes the allowed NSSAIs stored for this PLMN or SNPN and, if available, deletes the mapped S-NSSAIs stored for the allowed NSSAIs.
c) When the UE receives the S-NSSAI(s) included in the rejected NSSAI in the REGISTRATION ACCEPT message, the REGISTRATION REJECT message, the DEREGISTRATION REQUEST message or in the CONFIGURATION UPDATE COMMAND message, the UE shall:
1) store the S-NSSAI(s) into the rejected NSSAI based on the associated rejection cause(s);
2) remove from the stored allowed NSSAI for the current PLMN or SNPN, if any, included in the:
i) rejected NSSAI for the current PLMN or SNPN, for each and every access type;
ii) rejected NSSAI for the current registration area, associated with the same access type; and
iii) rejected NSSAI for each and every connection type, either NSSAA failure or withdrawal;
3) remove from the stored pending NSSAI for the current PLMN or SNPN, if any, included in the:
i) rejected NSSAI for the current PLMN or SNPN, for each and every access type;
ii) rejected NSSAI for the current registration area, associated with the same access type; or
iii) Rejected NSSAI for each and every connection type, either NSSAA failure or withdrawal;

When the UE:
1) deregisters from the current PLMN using explicit signaling or enters 5GMM-DEREGISTERED state for the current PLMN; or
2) successfully registers with a new PLMN;
3) enters state 5GMM-DEREGISTERED following an unsuccessful registration with a new PLMN; or
and the UE is not registered with the current PLMN or SNPN over another access, the rejected NSSAI for the current PLMN shall be deleted.

When the UE:
1) deregisters over an access type;
2) successfully registers in a new registration area over an access type; or
3) enters state 5GMM-DEREGISTERED or 5GMM-REGISTERED following an unsuccessful registration in a new registration area over an access type,
the rejected NSSAI for the current registration area corresponding to the access type shall be deleted;
d) If the UE receives one or more S-NSSAIs included in the pending NSSAI in the Registration Accept message, the UE stores one or more S-NSSAIs for the pending NSSAI.

When the UE:
1) deregisters with the current PLMN using explicit signalling or enters state 5GMM-DEREGISTERED for the current PLMN;
2) successfully registers with a new PLMN;
3) enters state 5GMM-DEREGISTERED following an unsuccessful registration with a new PLMN;
4) successful complete the attach or tracking area update procedure in S1 mode; or
5) initiates an attach or tracking area update procedure in S1 mode and receives an attach reject message or tracking area update reject message;
and the UE is not registered with the current PLMN over another access, the pending NSSAI for the current PLMN shall be deleted.
e) For PLMN, if the UE receives a Network Slicing Indication IE with Network Slicing Subscription Change Indication set to “Network slicing subscription changed” in a Registration Accept message or a Configuration Update Command message, the UE deletes the network slicing information for each PLMN (except the current PLMN) where it stores network slicing information. The UE does not delete the default Configured NSSAI. Additionally, the UE updates the network slicing information for the current PLMN as mentioned in a), b), c) and e) above (if received).

The pending NSSAI is the NSSAI provided by the serving PLMN during the registration procedure, and indicates the S-NSSAI for which the network slice-specific authentication and authorization procedure is pending.

### 1. UE Network Slice Configuration

The Network Slice configuration information contains one or more Configured NSSAI(s). A Configured NSSAI may either be configured by a Serving PLMN and apply to the Serving PLMN, or may be a Default Configured NSSAI configured by the HPLMN and that applies to any PLMNs for which no specific Configured NSSAI has been provided to the UE. There is at most one Configured NSSAI per PLMN.

NOTE 1: The value(s) used in the Default Configured NSSAI are expected to be commonly decided by all roaming partners, e.g. by the use of values standardized by 3GPP or other bodies.

The Default Configured NSSAI, if it is configured in the UE, is used by the UE in a Serving PLMN only if the UE has no Configured NSSAI for the Serving PLMN.

The Configured NSSAI of a PLMN may include S-NSSAIs that have standard values or PLMN-specific values.

The Configured NSSAI for the Serving PLMN includes the S-NSSAI values which can be used in the Serving PLMN and may be associated with mapping of each S-NSSAI of the Configured NSSAI to one or more corresponding HPLMN S-NSSAI values.

A UE subscription may contain Network Slice Simultaneous Registration Group (NSSRG) information.

The UE may be pre-configured with the Default Configured NSSAI. The UE may be provisioned/updated with the Default Configured NSSAI, determined by the UDM in the HPLMN, using the UE Parameters Update via UDM Control Plane. Each S-NSSAI in the Default Configured NSSAI may have a corresponding S-NSSAI as part of the Subscribed S-NSSAI(s). Consequently, if the Subscribed S-NSSAI(s) which are also present in the Default Configured NSSAI are updated the UDM should update the Default Configured NSSAI in the UE.

When providing a Requested NSSAI to the network upon registration, the UE in a given PLMN only includes and uses S-NSSAIs applying to this PLMN. The mapping of S-NSSAIs of the Requested NSSAI to HPLMN S-NSSAIs may also be provided. The S-NSSAIs in the Requested NSSAI are part of the Configured and/or Allowed NSSAIs applicable for this PLMN, when they are available. If the UE has received NSSRG information together with the Configured NSSAI, it only includes in the Requested NSSAI S-NSSAIs that all share a common NSSRG. If no Configured NSSAI and Allowed NSSAI for the PLMN are available, the S-NSSAIs in the Requested NSSAI correspond to the Default Configured NSSAI, if configured in the UE. Upon successful completion of a UE's Registration procedure over an Access Type, the UE obtains from the AMF an Allowed NSSAI for this Access Type, which includes one or more S-NSSAIs and, if needed, their mapping to the HPLMN S-NSSAIs. These S-NSSAIs are valid for the current Registration Area and Access Type provided by the AMF the UE has registered with and can be used simultaneously by the UE (up to the maximum number of simultaneous Network Slice instances or PDU Sessions).

The UE might also obtain one or more rejected S-NSSAIs with cause and validity of rejection from the AMF. An S-NSSAI may be rejected:
for the entire PLMN; or
for the current Registration Area.

While it remains RM-REGISTERED in the PLMN and regardless of the Access Type, the UE shall not re-attempt to register to an S-NSSAI rejected for the entire PLMN until this rejected S-NSSAI is deleted as specified below.

While it remains RM-REGISTERED in the PLMN, the UE shall not re-attempt to register to an S-NSSAI rejected in the current Registration Area until it moves out of the current Registration Area.

S-NSSAIs that the UE provides in the Requested NSSAI which are neither in the Allowed NSSAI nor provided as a rejected S-NSSAI, shall, by the UE, not be regarded as rejected, i.e. the UE may request to register these S-NSSAIs again next time the UE sends a Requested NSSAI.

The UE stores (S-) NSSAIs as follows:
The Allowed NSSAI received in a Registration Accept message or a UE Configuration Update Command applies to a PLMN when at least a TAI of this PLMN is included in the RA/TAI list included in this Registration Accept message or UE Configuration Update Command. If the UE Configuration Update Command contains an Allowed NSSAI but not a TAI List, then the last received RA/TAI list applies for the decision on which PLMN(s) the Allowed NSSAI is applicable. If received, the Allowed NSSAI for a PLMN and Access Type and any associated mapping of this Allowed NSSAI to HPLMN S-NSSAIs shall be stored in the UE. The UE should store this Allowed NSSAI and any associated mapping of this Allowed NSSAI to HPLMN S-NSSAIs also when the UE is turned off, or until the network slicing subscription changes:

NOTE 3: Whether the UE stores the Allowed NSSAI and any associated mapping of the Allowed NSSAI to HPLMN S-NSSAIs also when the UE is turned off is left to UE implementation.
If received, an S-NSSAI rejected for the entire PLMN shall be stored in the UE while RM-REGISTERED in this PLMN regardless of the Access Type or until it is deleted.
If received, an S-NSSAI rejected for the current Registration Area shall be stored in the UE while RM-REGISTERED until the UE moves out of the current Registration Area or until the S-NSSAI is deleted.

### 2. Network Slice-Specific Authentication and Authorization

During registration procedure, the AMF shall provide a “NSSAA to be performed” indicator and no Allowed NSSAI to the UE in the Registration Accept message. Upon receiving the Registration Accept message, the UE is registered in the PLMN but shall wait for the completion of the Network Slice-Specific Authentication and Authorization without attempting to use any service provided by the PLMN on any access until the UE receives an allowed NSSAI.

Then, the AMF shall initiate the Network Slice-Specific Authentication and Authorization procedure for each S-NSSAI that requires it, except, based on Network policies, for those S-NSSAIs for which Network Slice-Specific Authentication and Authorization have been already initiated on another Access Type for the same S-NSSAI(s). At the end of the Network Slice-Specific Authentication and Authorization steps, the AMF by means of the UE Configuration Update procedure shall provide a new Allowed NSSAI to the UE which also contains the S-NSSAIs subject to Network Slice-Specific Authentication and Authorization for which the authentication and authorization is successful. The AMF may perform AMF selection when NSSAA completes for the S-NSSAIs subject to NSSAA. If an AMF change is required, this shall be triggered by the AMF using the UE Configuration Update procedure indicating a UE re-registration is required. The S-NSSAIs which were not successfully authenticated and authorized are not included in the Allowed NSSAI and are included in the list of Rejected S-NSSAIs with a rejection cause value indicating Network Slice-Specific Authentication and Authorization failure.

The network may include a pending NSSAI in the registration acknowledgement message to inform the UE of one or more pending S-NSSAIs due to network slice specific authentication and authorization procedures not being completed.

### Disclosure of the Present Specification

If authentication and authorization procedures are required for a specific network slice, the AMF may include a Pending NSSAI (which includes an NSSAI (S-NSSAI #1) corresponding to the specific network slice) in a registration accept message and transmit it to the terminal.

Upon receiving the registration accept message, the terminal may store the NSSAI (S-NSSAI #1) corresponding to the specific network slice in the Pending NSSAI. The NAS layer of the terminal may perform the above operation.

If the authentication and authorization procedures are successfully performed for a specific network slice, the AMF may include an Allowed NSSAI (which includes an NSSAI (S-NSSAI #1) corresponding to the specific network slice) in a CONFIGURATION UPDATE COMMAND and transmit it to the terminal.

The terminal may want a service for a new network slice (S-NSSAI #2). Only if the above new network slice (S-NSSAI #2) is included in the same NSSRG as Allowed NSSAI and Pending NSSAI, the UE may transmit a registration request message including S-NSSAI #2 to the network.

If the above new network slice (S-NSSAI #2) is not included in the same NSSRG as Allowed NSSAI and Pending NSSAI, a deregistration procedure must be performed before transmitting the registration request message.

In this regard, after storing the NSSAI corresponding to the specific network slice in the Pending NSSAI, the UE may no longer want the service related to the specific network slice. In this case, the processing thereof is problematic.

The UE may receive Pending NSSAI information provided by the serving PLMN during the registration procedure (e.g., in the Registration Acceptance message). The Pending NSSAI information may indicate the S-NSSAI for which the network slice-specific authentication and authorization procedure is pending. When the UE transmits another new registration request later, the UE may not include the S-NSSAI in the pending NSSAI list. The assumption of this procedure is that the UE is still interested in the S-NSSAI in the pending NSSAI.

However, it was discussed that there is the case that the UE may no longer be interested in the S-NSSAI that the UE has previously requested for the service. In fact, the user may abort the previously requested service any time. In this case, however, according to the current procedure, the UE may not be able to request the S-NSSAI that in the NSSRG (Network Slice Simultaneous Registration Group) information associated with the S-NSSAI in the pending NSSAI list although the S-NSSAI is no longer interested in the UE.

Example scenario may be as follows:
i) The UE may receive S-NSSAI #3 not in the same NSSRG with that of S-NSSAI #1 in the Registration accept message or Configuration update command message.
ii) The UE may store S-NSSAI #3 in NSSRG information.
iii) Upper layers may request a service associated with S-NSSAI #1.
iv) The UE may transmit S-NSSAI #1 in the requested NSSAI in the Registration request message.
v) The UE may receive S-NSSAI #1 in the pending NSSAI in the Registration accept message.
vi) The UE may store S-NSSAI #1 in the pending NSSAI list.
vii) The user may be no longer interested in the service associated with S-NSSAI #1.
viii) The user may be interested in the service associated with S-NSSAI #3 and upper layers may request a service associated with S-NSSAI #3. However, the UE may not transmit the registration request including S-NSSAI #3 in the requested NSSAI.

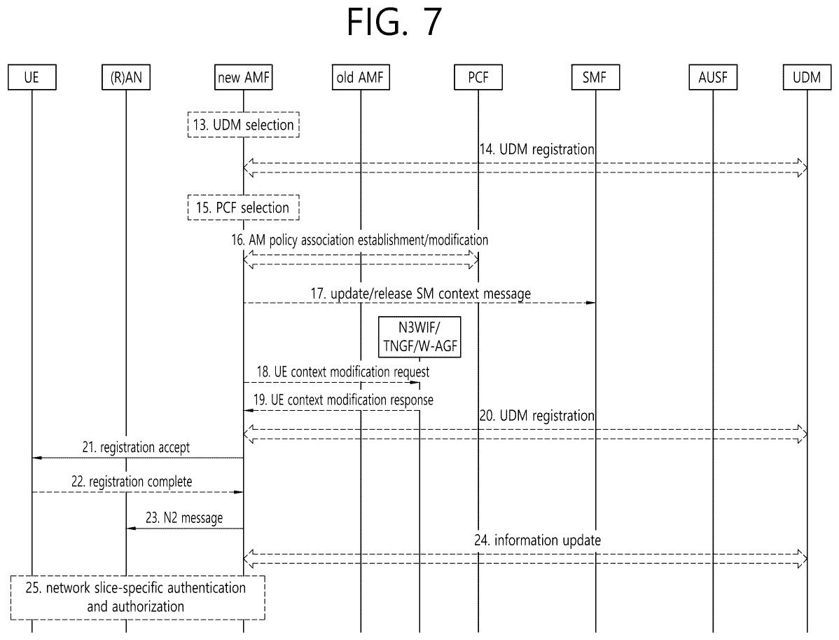

FIG. 8 shows the registration procedure related to the network slice.

The upper layer of the terminal may initiate a service (e.g., MO signaling, MO data, etc.).

The terminal may transmit a registration request message including the Requested NSSAI to the AMF.

The Requested NSSAI may include the NSSAI for the network slice from which the terminal wants to receive the service.

The terminal may use the service only if the NSSAI included in the Requested NSSAI is not included in the Rejected NSSAI or the Pending NSSAI later.

The terminal may receive a registration accept message from the AMF.

The registration accept message may include the Pending NSSAI, the Allowed NSSAI, and the Mapping of Pending NSSAI.

The terminal may store the received NSSAI information (Pending NSSAI, Allowed NSSAI, Mapping of Pending NSSAI) in the storage.

In order to handle a Pending NSSAI that is no longer of interest, the upper layer of the terminal may transmit an indication that it is no longer interested in the service (a service for which the terminal previously requested service initiation but the procedure has not yet been completed, e.g., a service for which the terminal is waiting for a response from the network (the completion of the authentication and authorization procedure of the network slice)).

According to the disclosure of this specification, the service information transmitted from the upper layer may include the following:
Service identifier (e.g., Service can be IMS, V2X), or
Application identifier, or
Slice information (e.g., S-NSSAI), or
Operator specific service identifier

The following drawings are created to explain specific examples of this specification. The names of specific devices or names of specific signals/messages/fields described in the drawings are provided for illustrative purposes, and therefore, the technical features of this specification are not limited to the specific names used in the drawings below.

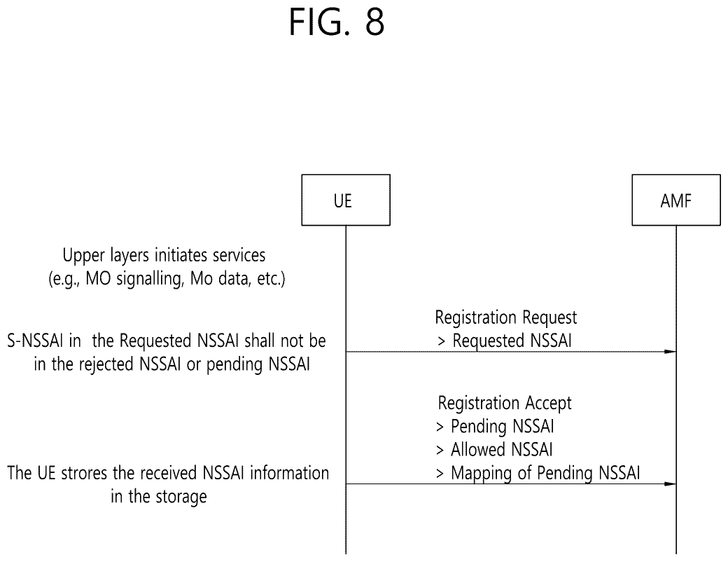

FIG. 9 illustrates a procedure according to an embodiment of this specification.

Step 1. The terminal may initiate a particular service (e.g., application #1).

The upper layer of the terminal may inform the service initiation request to the NAS (Non-access stratum) layer of the terminal. The upper layer of the terminal may transmit the service initiation request to the NAS layer of the terminal.

The service initiation request may be the type of identifier (e.g., application identifier, service identifier, slice identifier, etc.). The type of identifier may include at least one of an application identifier, a service identifier, and a slice identifier.

The service initiation request may be a particular traffic (e.g., user data).

Step 2. The terminal may transmit a registration request message to a network (e.g., AMF) to request service registration.

The terminal may transmit the registration request message including a Requested NSSAI parameter (S-NSSAI #1) related to the service started by the terminal.

Step 3. The terminal may receive NSSRG information from the network. The network may be AMF.

NSSRG information may be included in a registration accept message or a configuration update command.

NSSRG information may include NSSRG (e.g., the first NSSRG) information corresponding to S-NSSAI #1 requested by the terminal.

NSSRG of S-NSSAI #1 and NSSRG of S-NSSAI #3 (NSSAI for a new service desired by the terminal after step 6) may be different.

NSSRG information may include that NSSRG of S-NSSAI #1 and NSSRG of S-NSSAI #3 are different. For example, NSSRG information may include that S-NSSAI #1 corresponds to the first NSSRG and S-NSSAI #3 corresponds to the second NSSRG.

When the terminal receives NSSRG information, it may store NSSRG information and related slice information.

Step 4. The terminal may receive a registration accept message.

The registration accept message may receive Pending NSSAI information including the S-NSSAI requested in step 2.

The registration accept message may include Pending NSSAI, Allowed NSSAI, and Mapping of Pending NSSAI. The Pending NSSAI may include the S-NSSAI (S-NSSAI #1) requested in step 2.

The terminal may store the received NSSAI information (Pending NSSAI, Allowed NSSAI, Mapping of Pending NSSAI). When the terminal receives the Pending NSSAI information, it may store the Pending NSSAI.

For example, the terminal may store S-NSSAI #1 in the Pending NSSAI list.

Step 5. The upper layer of the terminal may indicate that the terminal is no longer interested in the previously requested service.

The upper layer of the terminal may transmit the abort indication for the previously requested service initiation to the NAS layer of the terminal.

The upper layer of the terminal may transmit the abort indication for S-NSSAI #1 to the NAS layer of the terminal.

The upper layer of the terminal may transmit the command for service abortion to the NAS layer of the terminal as shown in Table 3.

TABLE 3

```
    1. Attach procedure
  1.1. Send AT: “AT+CGDCONT=1,“IP”“”
  1.2. Send AT: “AT+CGACT=1,1”
  1.3. Default EPS bearer activation procedure
2. Bearer resource allocation procedure
  2.1. Send AT: “AT+CGDCONT=2,1”
  2.2. Send AT: “AT+CGEQOS=2,4,48,48,48,48”
  2.3. Send AT:
“AT+CGTFT=2,1,15,\”10.2.1.10.255.255.255.255\“,,,,,,,3”
  2.4. Send AT: “AT+CGACT=1,2”
3. Abort procedure
  3.1. Send AT:“a”
```

5 The terminal may delete user traffic from the data buffer when it is no longer interested in the service.

Step 6. If the terminal is no longer interested in the service stored in the Pending NSSAI, the terminal may remove the relevant slice information from the Pending NSSAI list.

The NAS layer of the terminal may be notified that a specific service is no longer of interest to the terminal.

The NAS layer of the terminal may be notified that a specific application is no longer of interest to the terminal.

The NAS layer of the terminal may be notified that a specific slice associated with a previously requested service is no longer of interest to the terminal.

The NAS layer of the terminal may delete the S-NSSAI which is no longer interested in the UE in the pending NSSAI list.

The NAS layer of the terminal may delete S-NSSAI #1 from the Pending NSSAI list.

The terminal may no longer want the specific service of step 1. For example, the terminal may determine that it no longer wants the specific service. Based on this, the terminal may delete S-NSSAI #1 for the specific service from the Pending NSSAI.

If the UE is still interested in the S-NSSAI of the Pending NSSAI, the UE may consider the S-NSSAI of the Pending NSSAI as the S-NSSAI requested by the UE. Therefore, the UE may consider the S-NSSAI of the Pending NSSAI that the UE is still interested in to apply the NSSRG restriction. If the S-NSSAI of the Pending NSSAI is no longer of interest to the UE, the UE may delete the S-NSSAI.

Step 7. The NAS layer of the UE may receive a service initiation request for a new service from the upper layer of the UE.

If the UE wants a new service, the upper layer of the UE may transmit a service initiation request for the new service to the NAS layer of the UE.

If Step 6 is not performed (i.e., the S-NSSAI #1 in the Pending NSSAI is not deleted), the UE may determine whether the NSSRG of the S-NSSAI #3 and the NSSRG of the S-NSSAI #1 for the new service are the same. Depending on the result, the following may be performed:
If not same, the UE may transmit a registration request message including a Request NSSAI including S-NSSAI #3 to the AMF after performing a deregistration procedure for S-NSSAI #1.
If same, the UE may not perform a deregistration procedure and transmit a registration request message including a Request NSSAI including S-NSSAI #3 to the AMF.

Whether the NSSRGs are same may be determined based on the NSSRG information received from the AMF.

Step 8. The NAS layer of the terminal (UE) may transmit a registration request message including a Request NSSAI including S-NSSAI #3 to the AMF.

The terminal may consider the S-NSSAI of the Pending NSSAI to apply the NSSRG restriction only if the terminal is still interested in the S-NSSAI.

Even if the terminal is no longer interested in the S-NSSAI of the Pending NSSAI, the terminal may still apply the NSSRG restriction to the S-NSSAI.
i) When the network slice-specific authentication and authorization procedures for the S-NSSAI in Pending NSSAI are completed, or ii) When the terminal is no longer interested in the S-NSSAI in Pending NSSAI, the S-NSSAI may be moved to Allowed NSSAI or Rejected NSSAI depending on the procedure result.

### 1. NSSAI Storage

If available, the configured NSSAI(s) shall be stored in a non-volatile memory in the ME (Mobile Equipment). For a configured NSSAI, if there is associated NSSRG information, the NSSRG information may also have to be stored in a non-volatile memory in the ME. For a configured NSSAI, if there is associated NSAG information, the NSAG information may have to be stored in the ME. The support for NSSRG information and NSAG information by a UE or an AMF is optional.

The allowed NSSAI(s) may have to be stored in a non-volatile memory in the ME.

Each of the configured NSSAI stored in the UE may be a set composed of at most 16 S-NSSAIs. Each of the allowed NSSAI stored in the UE may be a set composed of at most 8 S-NSSAIs and may be associated with a PLMN identity or SNPN identity, an access type and, if the UE supports access to an SNPN using credentials from a credentials holder, the selected entry of the “list of subscriber data” or the selected PLMN subscription. Each of the configured NSSAI except the default configured NSSAI, and the rejected NSSAI is associated with a PLMN identity or SNPN identity and, if the UE supports access to an SNPN using credentials from a credentials holder, the selected entry of the “list of subscriber data” or the selected PLMN subscription. Each of the pending NSSAI stored in the UE is a set composed of at most 16 S-NSSAIs and is associated with a PLMN identity or SNPN identity and, if the UE supports access to an SNPN using credentials from a credentials holder, the selected entry of the “list of subscriber data” or the selected PLMN subscription. The S-NSSAI(s) in the rejected NSSAI for the current registration area are further associated with one or more tracking areas where the rejected S-NSSAI(s) is not available. The S-NSSAI(s) in the rejected NSSAI for the current PLMN or SNPN shall be considered rejected for the current PLMN or SNPN regardless of the access type. The S-NSSAI(s) in the rejected NSSAI for the failed or revoked NSSAA shall be considered rejected for the current PLMN or SNPN regardless of the access type. The S-NSSAI(s) in the rejected NSSAI for the maximum number of UEs reached are further associated with the access type over which the rejected NSSAI was received. There shall be no duplicated PLMN identities or SNPN identities associated with each of the list of configured NSSAI(s), pending NSSAI(s), rejected NSSAI(s) for the current PLMN or SNPN, rejected NSSAI(s) for the current registration area, rejected NSSAI(s) for the failed or revoked NSSAA, and rejected NSSAI for the maximum number of UEs reached.

The UE stores NSSAIs as follows:
a) The configured NSSAI shall be stored until a new configured NSSAI is received for a given PLMN or SNPN. The network may provide to the UE the mapped S-NSSAI(s) for the new configured NSSAI which shall also be stored in the UE. When the UE is provisioned with a new configured NSSAI for a PLMN or SNPN, the UE may:
1) replace any stored configured NSSAI for this PLMN or SNPN with the new configured NSSAI for this PLMN or SNPN;
2) delete any stored mapped S-NSSAI(s) for the configured NSSAI and, if available, store the mapped S-NSSAI(s) for the new configured NSSAI;
3) delete any stored allowed NSSAI for this PLMN or SNPN and, if available, the stored mapped S-NSSAI(s) for the allowed NSSAI, if the UE received the new configured NSSAI for this PLMN or SNPN and the Configuration update indication IE with the Registration requested bit set to “registration requested”, in the same CONFIGURATION UPDATE COMMAND message but without any new allowed NSSAI for this PLMN or SNPN included;
4) delete any stored rejected NSSAI, and stop the timer T3526 associated with the deleted rejected S-NSSAI for the maximum number of UEs reached if running;
4A) remove from the stored mapped S-NSSAI(s) for the rejected NSSAI for the current PLMN or SNPN and the stored mapped S-NSSAI(s) for the rejected NSSAI for the current registration area and the stored rejected NSSAI for the maximum number of UEs reached, the S-NSSAI(s), if any, included in the mapped S-NSSAI(s) for the new configured NSSAI for the current PLMN or SNPN (if the UE is roaming), and stop the timer T3526 associated with the deleted rejected S-NSSAI for the maximum number of UEs reached if running;
5) delete any S-NSSAI(s) stored in the pending NSSAI that are not included in the new configured NSSAI for the current PLMN or SNPN or any mapped S-NSSAI(s), if any, stored in the pending NSSAI that are not included in the mapped S-NSSAI(s) for the configured NSSAI (if the UE is roaming); and
5A) delete the S-NSSAI(s) stored in the pending NSSAI that is no longer interested in the UE;

The network may inform the network slice re-mapping information to the UE optionally including the time period that the re-mapped network slice may be available for. Then, the UE may perform the PDU session-related procedures based on the network slice re-mapping information. By doing this, the UE may learn the correct network slice deployment or configuration information, and may utilize it for the UE operation (e.g., MA PDU session procedures). Also, the network operation may be simplified because the network does not need to provide the transparent network slice re-mapping procedure to the UE and the UE operates based on the updated slice information. Without updating URSP rules by PCF, the network may prohibit using congested network slice for a period of time.

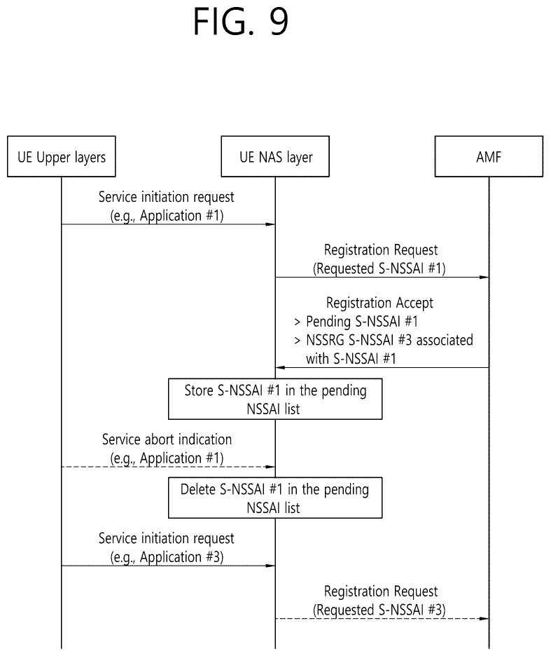

FIG. 10 shows the procedure of the NAS layer of the UE according to disclosure of the present specification.
1. The NAS layer of the UE may receive, from an upper layer of the UE, a service initiation request for a first service.
2. The NAS layer of the UE may transmit, to an AMF (Access and Mobility management Function), a registration request message including a requested NSSAI (Network Slice Selection Assistance Information).

The requested NSSAI may include a first S-NSSAI (single-NSSAI) related to the first service.
3. The NAS layer of the UE may receive, from the AMF, a registration accept message including a pending NSSAI.

The pending NSSAI may include the first S-NSSAI.
4. The NAS layer of the UE may store the first S-NSSAI in pending NSSAI list.
5. The NAS layer of the UE may receive, from the upper layer of the UE, indication to abort the service initiation request for the first service.
6. The NAS layer of the UE may delete the first S-NSSAI from the pending NSSAI list, based on the indication.

The NAS layer of the UE may receive, from the upper layer of the UE, a service initiation request for a second service.

The NAS layer of the UE may transmit, to the AMF, a new registration request message including a second S-NSSAI related to the second service, based on the deleting the first S-NSSAI from the pending NSSAI list.

The NAS layer of the UE may receive, from the AMF, NSSRG (Network Slice Simultaneous Registration Group) information.

The registration accept message may include NSSRG information.

The NSSRG information may include information that the second S-NSSAI corresponds to specific NSSRG.

The step of transmitting the new registration request message may be performed, based on i) NSSRG corresponding to the NSSAI existing in the pending NSSAI list being the specific NSSRG or ii) there being no NSSAI remaining in the pending NSSAI list.

The service initiation request for the first service may include at least one of an application identifier, a service identifier, a network slice identifier.

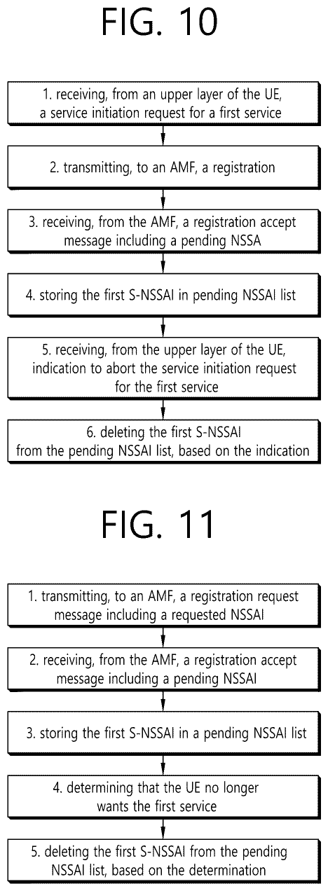

FIG. 11 shows the procedure of the UE according to disclosure of the present specification.
1. The UE may transmite, to an AMF (Access and Mobility management Function), a registration request message including a requested NSSAI (Network Slice Selection Assistance Information).

The requested NSSAI may include a first S-NSSAI (single-NSSAI) related to a first service.
2. The UE may receive, from the AMF, a registration accept message including a pending NSSAI.

The pending NSSAI may include the first S-NSSAI.
3. The UE may store the first S-NSSAI in a pending NSSAI list.
4. The UE may determine that the UE no longer wants the first service.
5. The UE may delete the first S-NSSAI from the pending NSSAI list, based on the determination.

The UE may transmit, to the AMF, a new registration request message including a second S-NSSAI related to a second service.

The UE may receive, from the AMF, NSSRG (Network Slice Simultaneous Registration Group) information.

The registration accept message may include NSSRG information.

The NSSRG information may include information that the second S-NSSAI corresponds to specific NSSRG.

The step of transmitting the new registration request message may be performed, based on i) NSSRG corresponding to the NSSAI existing in the pending NSSAI list being the specific NSSRG or ii) there being no NSSAI remaining in the pending NSSAI list.

The service initiation request for the first service may include at least one of an application identifier, a service identifier, a network slice identifier.

Hereinafter, an apparatus for performing communication according to some embodiments of the present specification will be described.

For example, the apparatus may include a processor, a transceiver, and a memory.

For example, a processor may be configured to be operably coupled with a memory and a processor.

The processor may perform: receiving, from an upper layer of the UE, a service initiation request for a first service; transmitting, to an AMF (Access and Mobility management Function), a registration request message including a requested NSSAI (Network Slice Selection Assistance Information); wherein the requested NSSAI includes a first S-NSSAI (single-NSSAI) related to the first service, receiving, from the AMF, a registration accept message including a pending NSSAI; wherein the pending NSSAI includes the first S-NSSAI, storing the first S-NSSAI in pending NSSAI list; receiving, from the upper layer of the UE, indication to abort the service initiation request for the first service; deleting the first S-NSSAI from the pending NSSAI list, based on the indication.

Hereinafter, a processor for providing communication according to some embodiments of the present specification will be described.

The processor is configured to: receiving, from an upper layer of the UE, a service initiation request for a first service; transmitting, to an AMF (Access and Mobility management Function), a registration request message including a requested NSSAI (Network Slice Selection Assistance Information); wherein the requested NSSAI includes a first S-NSSAI (single-NSSAI) related to the first service, receiving, from the AMF, a registration accept message including a pending NSSAI; wherein the pending NSSAI includes the first S-NSSAI, storing the first S-NSSAI in pending NSSAI list; receiving, from the upper layer of the UE, indication to abort the service initiation request for the first service; deleting the first S-NSSAI from the pending NSSAI list, based on the indication.

Hereinafter, a non-volatile computer readable medium storing one or more instructions for providing multicast service in wireless communication according to some embodiments of the present specification will be described.

According to some embodiments of the present disclosure, the technical features of the present disclosure may be directly implemented as hardware, software executed by a processor, or a combination of the two. For example, in wireless communication, a method performed by a wireless device may be implemented in hardware, software, firmware, or any combination thereof. For example, the software may reside in RAM memory, flash memory, ROM memory, EPROM memory, EEPROM memory, registers, hard disk, removable disk, CD-ROM, or other storage medium.

Some examples of a storage medium are coupled to the processor such that the processor can read information from the storage medium. Alternatively, the storage medium may be integrated into the processor. The processor and storage medium may reside in the ASIC. For another example, a processor and a storage medium may reside as separate components.

Computer-readable media can include tangible and non-volatile computer-readable storage media.

For example, non-volatile computer-readable media may include random access memory (RAM), such as synchronization dynamic random access memory (SDRAM), read-only memory (ROM), or non-volatile random access memory (NVRAM). Read-only memory (EEPROM), flash memory, magnetic or optical data storage media, or other media that can be used to store instructions or data structures or Non-volatile computer readable media may also include combinations of the above.

Further, the methods described herein may be realized at least in part by computer-readable communication media that carry or carry code in the form of instructions or data structures and that can be accessed, read, and/or executed by a computer.

According to some embodiments of the present disclosure, a non-transitory computer-readable medium has one or more instructions stored thereon. The stored one or more instructions may be executed by a processor of the base station.

The stored one or more instructions cause the processors to: receiving, from an upper layer of the UE, a service initiation request for a first service; transmitting, to an AMF (Access and Mobility management Function), a registration request message including a requested NSSAI (Network Slice Selection Assistance Information); wherein the requested NSSAI includes a first S-NSSAI (single-NSSAI) related to the first service, receiving, from the AMF, a registration accept message including a pending NSSAI; wherein the pending NSSAI includes the first S-NSSAI, storing the first S-NSSAI in pending NSSAI list; receiving, from the upper layer of the UE, indication to abort the service initiation request for the first service; deleting the first S-NSSAI from the pending NSSAI list, based on the indication.

The present specification may have various effects.

For example, a terminal can delete an S-NSSAI related to a service it no longer wants from the pending NSSAI, so that a registration request for a new service can be performed later without a separate deregistration.

Effects that can be obtained through specific examples of the present specification are not limited to the effects listed above. For example, various technical effects that a person having ordinary skill in the related art can understand or derive from this specification may exist. Accordingly, the specific effects of the present specification are not limited to those explicitly described herein, and may include various effects that can be understood or derived from the technical characteristics of the present specification.

The claims described herein may be combined in various ways. For example, the technical features of the method claims of the present specification may be combined and implemented as an apparatus, and the technical features of the apparatus claims of the present specification may be combined and implemented as a method. In addition, the technical features of the method claim of the present specification and the technical features of the apparatus claim may be combined to be implemented as an apparatus, and the technical features of the method claim of the present specification and the technical features of the apparatus claim may be combined and implemented as a method. Other implementations are within the scope of the following claims.

1. A method for performing communication, performed by a NAS (Non-access stratum) layer of a UE (User Equipment), comprising:
receiving, from an upper layer of the UE, a service initiation request for a first service;
transmitting, to an AMF (Access and Mobility management Function), a registration request message including a requested NSSAI (Network Slice Selection Assistance Information);
wherein the requested NSSAI includes a first S-NSSAI (single-NSSAI) related to the first service,
receiving, from the AMF, a registration accept message including a pending NSSAI;
wherein the pending NSSAI includes the first S-NSSAI,
storing the first S-NSSAI in pending NSSAI list;
receiving, from the upper layer of the UE, indication to abort the service initiation request for the first service;
deleting the first S-NSSAI from the pending NSSAI list, based on the indication.

2. The method of claim 1, further comprising:
receiving, from the upper layer of the UE, a service initiation request for a second service; and
transmitting, to the AMF, a new registration request message including a second S-NSSAI related to the second service, based on the deleting the first S-NSSAI from the pending NSSAI list.

3. The method of claim 2, further comprising:
receiving, from the AMF, NSSRG (Network Slice Simultaneous Registration Group) information.

4. The method of claim 2,
wherein the registration accept message includes NSSRG information.

5. The method of claim 3,
wherein the NSSRG information includes information that the second S-NSSAI corresponds to specific NSSRG,
wherein the step of transmitting the new registration request message is performed, based on i) NSSRG corresponding to the NSSAI existing in the pending NSSAI list being the specific NSSRG or ii) there being no NSSAI remaining in the pending NSSAI list.

6. The method of claim 1,
wherein the service initiation request for the first service includes at least one of an application identifier, a service identifier, a network slice identifier.

7. A method for performing communication, performed by a UE (User Equipment), comprising:
transmitting, to an AMF (Access and Mobility management Function), a registration request message including a requested NSSAI (Network Slice Selection Assistance Information);
wherein the requested NSSAI includes a first S-NSSAI (single-NSSAI) related to a first service,
receiving, from the AMF, a registration accept message including a pending NSSAI;
wherein the pending NSSAI includes the first S-NSSAI,
storing the first S-NSSAI in a pending NSSAI list;
determining that the UE no longer wants the first service;
deleting the first S-NSSAI from the pending NSSAI list, based on the determination.

8. The method of claim 7, further comprising:
transmitting, to the AMF, a new registration request message including a second S-NSSAI related to a second service.

9. The method of claim 8, further comprising:
receiving, from the AMF, NSSRG (Network Slice Simultaneous Registration Group) information.

10. The method of claim 8,
wherein the registration accept message includes NSSRG information.

11. The method of claim 9,
wherein the NSSRG information includes information that the second S-NSSAI corresponds to specific NSSRG,
wherein the step of transmitting the new registration request message is performed, based on i) NSSRG corresponding to the NSSAI existing in the pending NSSAI list being the specific NSSRG or ii) there being no NSSAI remaining in the pending NSSAI list.

12. (canceled)

13. A NAS (Non-access stratum) layer of a UE (User Equipment), comprising:
a transceiver; and
a processor,
wherein the processor performs operation comprising:
receiving, from an upper layer of the UE, a service initiation request for a first service;
transmitting, to an AMF (Access and Mobility management Function), a registration request message including a requested NSSAI (Network Slice Selection Assistance Information);
wherein the requested NSSAI includes a first S-NSSAI (single-NSSAI) related to the first service,
receiving, from the AMF, a registration accept message including a pending NSSAI;
wherein the pending NSSAI includes the first S-NSSAI,
storing the first S-NSSAI in pending NSSAI list;
receiving, from the upper layer of the UE, indication to abort the service initiation request for the first service;
deleting the first S-NSSAI from the pending NSSAI list, based on the indication.

14.-16. (canceled)

17. The NAS layer of claim 13, wherein the operation further comprises:
receiving, from the upper layer of the UE, a service initiation request for a second service; and
transmitting, to the AMF, a new registration request message including a second S-NSSAI related to the second service, based on the deleting the first S-NSSAI from the pending NSSAI list.

18. The NAS layer of claim 17, wherein the operation further comprises:
receiving, from the AMF, NSSRG (Network Slice Simultaneous Registration Group) information.

19. The NAS layer of claim 17,
wherein the registration accept message includes NSSRG information.

20. The NAS layer of claim 18,
wherein the NSSRG information includes information that the second S-NSSAI corresponds to specific NSSRG,
wherein the step of transmitting the new registration request message is performed, based on i) NSSRG corresponding to the NSSAI existing in the pending NSSAI list being the specific NSSRG or ii) there being no NSSAI remaining in the pending NSSAI list.

21. The NAS layer of claim 17,
wherein the service initiation request for the first service includes at least one of an application identifier, a service identifier, a network slice identifier.
